(19) United States
(12) Patent Application Publication
(10) Pub. No.: US 2023/0217863 A1
(43) Pub. Date: Jul. 13, 2023

(54) Dry Agricultural Trimmer

(71) Applicant: Ted Gillespie, Ontario, OR (US)

(72) Inventor: Ted Gillespie, Ontario, OR (US)

(21) Appl. No.: 17/575,570

(22) Filed: Jan. 13, 2022

(51) Int. Cl. A01G 3/08

(52) U.S. Cl. CPC A01G 3/08; A01G 2003/005

(57) ABSTRACT

An improved mechanical separator that functions without the use of mechanical blades. The separator uses a generally cylindrical barrel that houses an insert positioned circumferentially around the interior of the barrel. The insert is a cylindrical rigid plastic insert having a series of openings positioned around the insert. A plastic mesh bag fits within the insert. The insert provides support to the bag. Plant material to be separated is positioned within the mesh bag within the insert within the barrel. A lid is placed on the barrel. The barrel is positioned on a frame. The frame having a series of opposing wheels or rollers, with two pairs of opposing rollers being in a preferred embodiment. The barrel can then be rotated

### DESCRIPTION/HISTORY

This is a mechanical trimmer used to separate unwanted plant material from harvested flowers, buds, and small fruit. This trimmer is intended to be used after the unwanted plant material has dried.

Current trimming methods are difficult or costly for growers of any scale. Previous patents for mechanical trimmers require the use of blades. Blades can damage the buds or flowers.

### SUMMARY

The disclosed method and device both reduces cost and labor. A single person can trim more at a time without damaging the buds. This novel method uses a poly mesh, rather than metal blades. There is minimal contact between the machine and the bud. Rather than cutting, the machine uses soft abrasion to remove the small ‘sugar’ leaves.

The effort required is small to trim one to five pounds in about 10 to 15 minutes. This machine is operated by hand, with minimal moving parts. An optional electric motor attachment is available. This machine is also safer to operate and clean than other mechanical trimmers.

The basket and inserts are easily cleaned with a bleach water solution. The frame assembly can be broken down and stored within the drum.

This trimmer utilizes a food grade barrel in three sizes. The drum sizes are 30 gallons and 55 gallons respectively. Each drum can be used on a collapsible frame that is universal for all drum sizes. (See drawing Main Assembly) The frame breaks down for storage and transportation.

What is disclosed is mechanical blade free separator comprising. The separation has a barrel assembly that is supported by a frame. The frame has a series of rollers or wheels on which the barrel assembly rotates. The rollers can be positioned on axles extending between legs of the frame. One or more axles and associated wheels can be driven by a motor. The barrel assembly has a barrel. The barrel having a cylindrical shape having a wall defining a side of the barrel. The wall of the barrel defines an interior of the barrel. The barrel has a floor and a removable lid positioned opposite said floor. A rigid plastic insert is configured for insertion into the barrel. The rigid plastic insert is a tube or pipe like shape. The insert can be open ended at both ends. The insert is configured for placement in the interior of the barrel such that said rigid plastic insert is positioned immediately adjacent to the wall in a close fit. The rigid plastic insert has a plurality of openings therethrough. These openings can be rectangular.

A plastic mesh basket is configured for placement within the rigid plastic insert within the interior of the barrel. The rigid plastic insert is configured to support the mesh basket within the barrel assembly. Plant material, such as buds or berries is placed in the mesh basket. When the barrel assembly rotates, the mesh basket supported by the insert causes the separation of the softer plant material, such as leaves, from the more rigid material, such as berries or buds. The removable lid encloses the mesh basket and rigid plastic insert within the barrel. The softer plant material is expelled from the mesh basket into the interior by the rotation of the barrel assembly.

The rollers or wheels are positioned such that a curve of the wall extends between opposing rollers. This allows the rollers to support the barrel when placed on its side, and to allow the rolling of the barrel on the wheels. In one embodiment four legs support the rollers and barrel. The axles extend between the legs, with the rollers positioned on the opposing parallel axles. The barrel is preferably configured with a track or channel that serves as a guide for the barrel rolling on the rollers. The lid can threadingly engage with the barrel, or alternative attachment mechanisms can be utilized.

### BRIEF DESCRIPTION OF THE FIGURES

FIG. 1 is a perspective view of an embodiment of an assembled separator having a barrel assembly positioned on rollers positioned on a frame.

FIG. 2 is a perspective view of the frame having rollers of FIG. 1.

FIG. 3 is a perspective view of the interior of the embodiment of a barrel of the barrel assembly shown in FIG. 1.

FIG. 4 is a perspective view of an embodiment of an insert configured to support a mesh basket within the barrel of FIG. 3.

FIG. 5 is a perspective view of a mesh basket for positioning within the insert of FIG. 4 within a barrel.

FIG. 6 is a perspective view of the insert of FIG. 4 positioned within the interior of the barrel shown in FIG. 3.

FIG. 7 is a perspective view of the mesh basket positioned within the insert and barrel shown in FIG. 6.

FIG. 8 is a partially exploded view of the mesh basket positioned within the insert above the barrel.

FIG. 9 is a perspective view of a frame with a motor incorporated to drive rotation of the rollers.

### DETAILED DESCRIPTION OF THE FIGURES

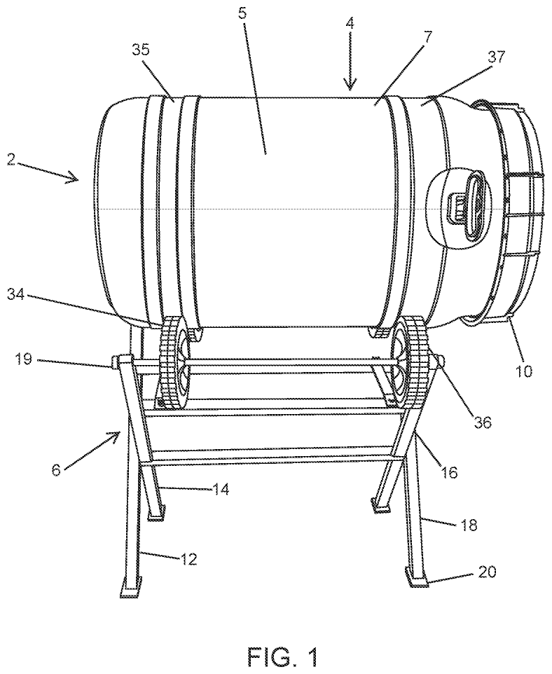

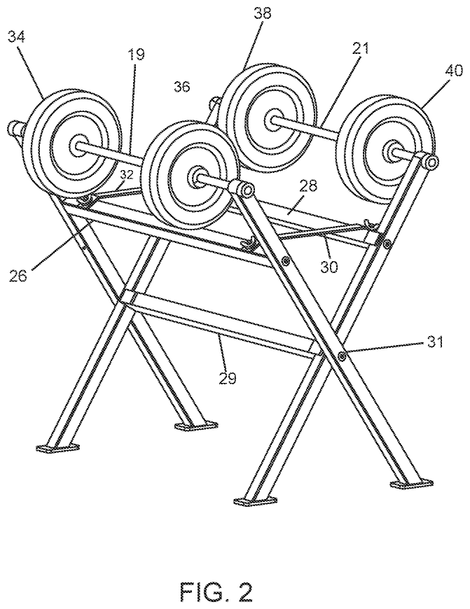

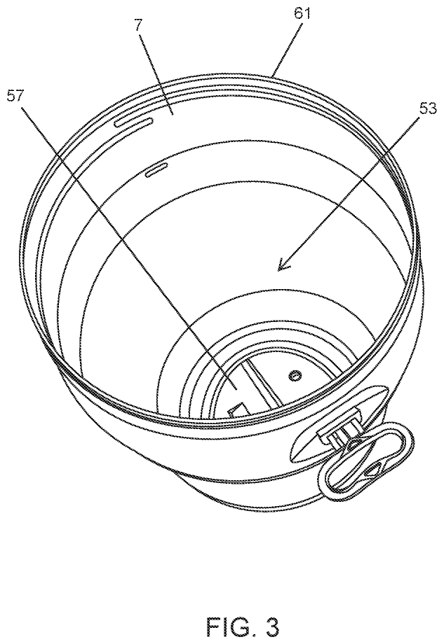

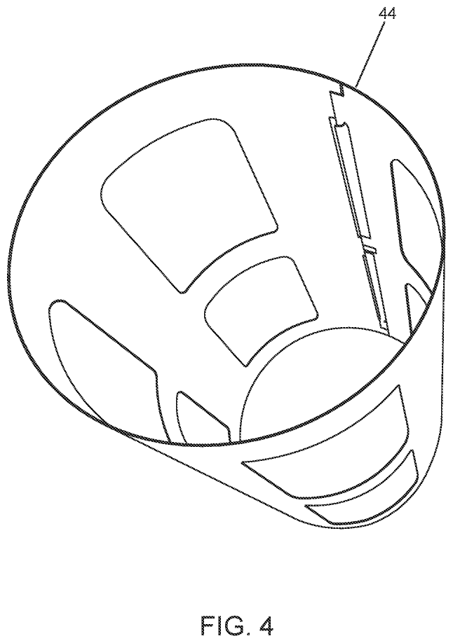

FIGS. 1-9 illustrate an improved mechanical trimmer 2 and components thereof. FIG. 1 illustrates a barrel assembly 4 of the improved mechanical trimmer positioned horizontally on the frame 6 of the improved mechanical trimmer. The frame in the depicted embodiment is built using 1″ square steel coated tubing. There are four upright legs 12, 14, 16, 18, with two legs each forming opposing X shapes. The legs each are provided with tab feet 20 at a base end that support the frame on any level work surface. The opposing legs are attached via two axles 19, 21 in a pair of axles extending between the legs and forming a common axis at the top end of each leg. The frame is stabilized by two parallel cross members 26, 28 and a third cross member 29 extending between the intersection 31 of the X formed by the pairs of legs. The parallel cross members are connected to each other by support brackets 30, 32.

High grade steel fasteners, and flanged wingnuts are used to secure the support bracket. The frame parts are preferably connected using flanged fasteners that are 1.5″ and 2.5″ respectively. Threaded caps are incorporated to allow for the flanged fastener to secure the frame components.

The longitudinal axles are supported by the frame using an attached bushing. Each axle has two separate 7″ wheels 34, 36, 38, 40, also called rollers. The wheels are held in place by attached clamping shaft collars. The wheels can be adjusted to accommodate multiple barrel sizes. Preferably the barrel has tracks or channels 35, 37 for positioning the barrel on the rollers and retaining the barrel in place on the rollers.

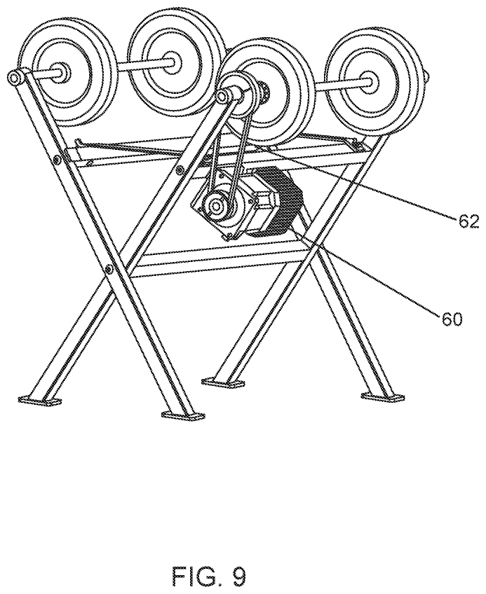

Food grade barrels will be guided horizontally by the wheels. The wheels surface provides agitation to the drum. The barrels can easily be rotated by hand, or by attaching an electric motor 60 with pulley 62 to drive rotation of one of the axles as shown in FIG. 9. The motor is attached via perforations in the frame. The barrel is generally cylindrical in shape having a wall 7 and a floor 57.

### Rotating Drum Sleeve:

The frame in FIG. 1 is shown supporting a food grade barrel. The adjustable wheel separation allows for the use of 30 gallon, and 55 gallon drums. The drum is rotated by hand or using an added electric motor when resting on the wheels.

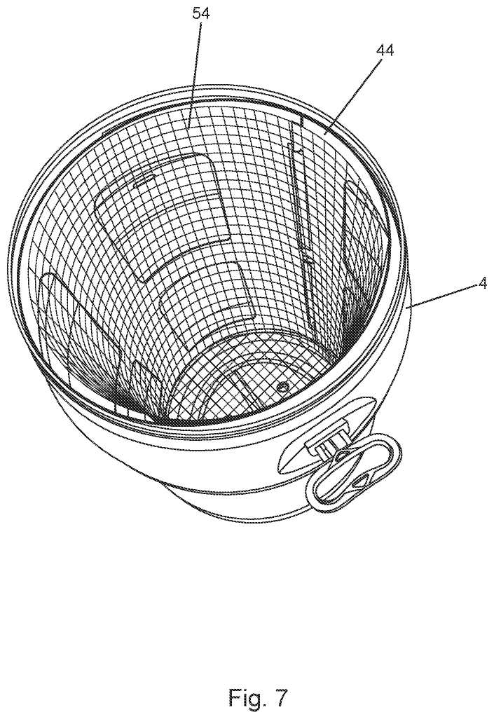

Each barrel assembly utilizes a styrene plastic insert 44 or sleeve to support a plastic mesh basket 54. Excess plant material is trapped between the mesh and the interior of the barrel. The mesh is separated from the interior of the barrel by the insert that fits into the drum, as shown in FIG. 7. The insert has openings 39 to allow for material to pass from the mesh bag to the space between the bag and the wall of the barrel.

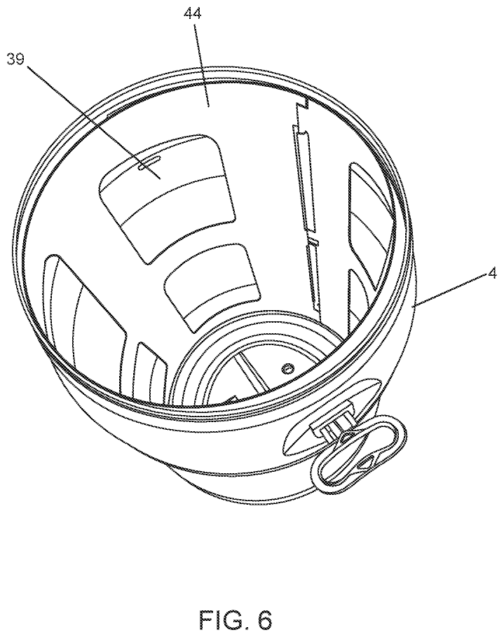

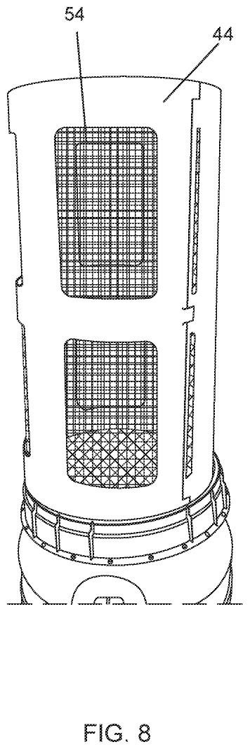

As illustrated in FIG. 6, the sleeve fits tightly to the interior of the barrel. This adds to the structural integrity of the design. As shown if FIGS. 7 and 8, the mesh basket 54 slides into the sleeve, and is held in place while the trimmer is being operated.

The drum sizes are 30 gallons, and 55 gallons. Each size allows for a different volume and can accommodate gardeners to large farms.

### Mesh Basket:

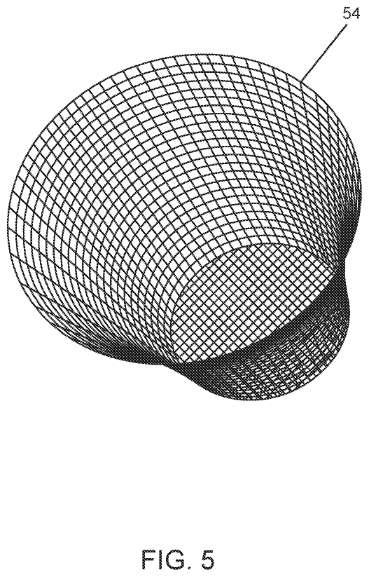

The mesh basket 54 is designed to fit within the drum. (See FIGS. 5, 7, and 9. The basket slides into the barrel insert through the mouth of the barrel.

This design includes the use of a plastic mesh to separate unwanted plant material from harvested plants.

By using a design without blades, this trimmer can be opened up to more delicate fruits as well.

After the basket is inserted into the barrel and sleeve, the product can be added to the basket.

The primary use would be for buds or flowers; however, it could also accommodate berries and the like. In contrast, typical previous concepts that are not as versatile.

The mesh sizes can vary. The mesh ranges from ¼ inch to 1 inch for various plants. Custom weave sizes available to produce baskets.

### Operation and Use:

When the frame is fully assembled, the barrel insert is placed securely into the barrel as shown in FIG. 6. The mesh basket can then be inserted into the barrel where it will be held in place by the insert as shown in FIG. 7. FIG. 8 illustrates the mesh basket and insert removed from the barrel in place to be slid into the void 53 of the barrel. The prepped material will have any large, or sun leaves, and stems removed. The dried and prepped material is placed into the barrel and the lid 10 is attached, such as by threaded engagement 61 as shown in the figures.

The barrel with prepped material lies horizontally on the wheels supported by the frame as shown in FIG. 1. The operator then rotates the barrel at the desired speed for 10 to 15 minutes.

The barrel is then removed from the Frame. The barrel can then be opened. The basket can then be pulled from the insert. The basket holds the harvested bud, flower, or fruit, and the trim material remains in the barrel. The trim can be repurposed or disposed of.

The machine can then be sanitized easily using a concentration of 1000 ppm chlorine and water, (¼ cup bleach for 1 gallon water) or cleaning alcohol. The sanitizing solution is then poured into the barrel, and is cycled on the frame for 2 minutes. The barrel should then be air dried prior to storage.

What is claimed is:

1-14. (canceled)

15. A mechanical separator comprising:
a barrel assembly, said barrel assembly comprising:
a barrel, said barrel comprising a cylindrical shape having a wall defining a side of the barrel defining an interior of the barrel, said barrel comprising a floor and a removable lid positioned opposite said floor;
a rigid plastic insert, wherein said rigid plastic insert comprises a tube configured for placement in said interior of said barrel such that said rigid plastic insert is positioned immediately adjacent to said wall, said rigid plastic insert comprising a plurality of openings therethrough;
a plastic mesh basket configured for placement within said rigid plastic insert within said interior of said barrel, wherein said rigid plastic insert is configured to support said mesh basket within said barrel assembly, said mesh basket defining a plurality of openings wherein said barrel assembly is configured such that said mesh basket is placed within said rigid plastic insert within said barrel and said removable lid encloses said mesh basket and rigid plastic insert within said barrel;
a frame, said frame comprising a series of opposing rollers, wherein said rollers are configured to support said barrel on opposing sides of a curve of said wall of said barrel when said barrel is positioned on a side of said barrel, wherein said rollers are configured to allow rotation of said barrel on its side.

16. The mechanical separator of claim 15, wherein said frame comprises a plurality of legs configured for supporting said barrel assembly on the ground.

17. The mechanical separator of claim 16, wherein said opposing rollers comprise pairs of opposing rollers, wherein said plurality of legs comprise two pairs of legs, wherein a pair of axles extends between said pairs of legs, wherein said rollers are each mounted on the pairs of axles.

18. The mechanical separator of claim 17, wherein said pairs of legs are configured in an X shape.

19. The mechanical separator of claim 15, wherein said frame comprises a motor configured to drive rotation of at least some of said pairs of rollers.

20. The mechanical separator of claim 15, wherein said barrel comprises a pair of channels configured for receiving said rollers.

21. The mechanical separator of claim 15, wherein said plurality of openings in said rigid plastic insert comprises a series of rectangular openings.

22. The mechanical separator of claim 1, wherein said barrel comprises a food grade barrel.

23. The mechanical separator of claim 1, wherein said lid of said barrel is threadingly attached to said barrel.
